(19) United States
(12) Patent Application Publication
(10) Pub. No.: US 2018/0001713 A1
(43) Pub. Date: Jan. 4, 2018

(54) PNEUMATIC TIRE

(71) Applicant: TOYO TIRE & RUBBER CO., LTD., Osaka (JP)

(72) Inventor: Tsuyoshi Fujioka, Osaka-shi (JP)

(73) Assignee: TOYO TIRE & RUBBER CO., LTD., Osaka (JP)

(21) Appl. No.: 15/617,279

(22) Filed: Jun. 8, 2017

(30) Foreign Application Priority Data
Jun. 30, 2016 (JP) 2016-130536

(51) Int. Cl. B60C 11/12; B60C 11/03; B60C 11/13

(52) U.S. Cl. CPC B60C 11/1236; B60C 11/1353; B60C 11/1204; B60C 11/0309; B60C 2011/1213; B60C 2011/1361

(57) ABSTRACT

In a pneumatic tire, a plurality of main grooves extending in a tire circumferential direction, a plurality of lateral grooves extending in a direction intersecting the main grooves, and block rows formed by the main grooves and the lateral grooves is provided at a tread portion. Recessed notches extending from a block upper surface to a block bottom portion are respectively provided in side surface portions of the blocks facing each other with the main groove interposed therebetween, and a reinforcing projection portion connecting the notches is provided in the groove bottom of the main groove.

### CROSS-REFERENCE TO RELATED APPLICATIONS

This application is based upon and claims the benefit of priority from the prior Japanese Patent Application No. 2016-130536, filed on Jun. 30, 2016; the entire contents of which are incorporated herein by reference.

### BACKGROUND

1. Field of the Invention

This embodiment relates to a pneumatic tire.

2. Related Art

There is a pneumatic tire in which block rows are formed at a tread portion by main grooves extending in a tire circumferential direction and lateral grooves intersecting the main grooves. In the related art, various structures have been proposed. For example, US2014/360639A1 discloses a configuration in which notches are provided at a pair of side surface portions facing main grooves, in a block formed by the main grooves and lateral grooves. In addition, US2006/016536A1 discloses a configuration in which a “biting element” is provided in a tread portion to connect blocks facing each other with a circumferential groove interposed therebetween, and an edge portion is increased and a static friction characteristic is improved by the biting element. On the other hand, US2008/149242A1 discloses a configuration in which in order to improve an anti-stone drilling property, protrusions, which are lower than a height of a block and separated from the block, are intermittently provided in a groove bottom of a groove portion provided in a tread portion. Here, the stone drilling is a phenomenon in which the groove portion bites a stone during tire running, the biting stone bites into the groove bottom due to rolling of the tire, and thereby a crack in the groove bottom or the like is caused by the biting stone.

In a tire with a block pattern, it is required to improve a traction property. In order to improve the traction property, if notches are provided in the side surface portion of the block, rigidity of the block reduces and the movement of the block increases, thereby causing uneven wear. In addition, in a pneumatic tire, it may be required to improve anti-stone drilling.

### SUMMARY

An object of this embodiment is to improve an uneven wear resistance property while maintaining a traction property and suppressing stone drilling.

A pneumatic tire according to the embodiment has a tread portion which includes a plurality of main grooves extending in a tire circumferential direction, a plurality of lateral grooves extending in a direction intersecting the main grooves, and block rows formed by the main grooves and the lateral grooves, and having a plurality of blocks in a tire circumferential direction. Recessed notches extending from a block upper surface toward a block bottom portion are respectively provided in side surface portions of the blocks facing each other with the main groove interposed therebetween, and a reinforcing projection portion connecting the notches is provided in the groove bottom of the main groove.

### BRIEF DESCRIPTION OF THE DRAWINGS

FIG. 1 is a perspective view of a pneumatic tire according to an embodiment.

FIG. 2 is partially enlarged perspective view of a tread portion of the same embodiment.

FIG. 3 is a developed view illustrating a tread pattern of the same embodiment.

FIG. 4 is an enlarged plan view of a main portion of a tread portion of the same embodiment.

FIG. 5 is an enlarged perspective view of a main portion of the tread portion of the same embodiment.

FIG. 6 is a sectional view that is taken along line VI-VI of FIG. 4.

FIG. 7 is a sectional view that is taken along line VII-VII of FIG. 4.

### DETAILED DESCRIPTION

Hereinafter, embodiments will be described with reference to the drawings.

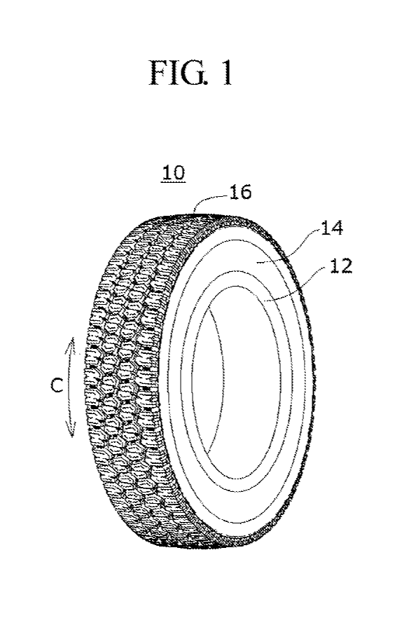

As illustrated in FIG. 1, a pneumatic tire 10 according to an embodiment includes a pair of right and left bead portions 12 and side wall portions 14, and a tread portion 16 that is provided between both side wall portions so as to connect radially outer end portions of the right and left side wall portions 14, and a general tire structure can be adopted for other than a tread pattern.

As illustrated in FIGS. 1 to 3, a plurality of block rows 22 formed by a plurality of main grooves 18 extending in a tire circumferential direction C and a plurality of lateral grooves 20 intersecting the main grooves 18 are provided on a tread rubber surface of the tread portion 16 in a tire width direction W.

In the example, three main grooves 18 are formed at intervals in the tire width direction W. A center main groove 18A positioned on a tire equator CL and a pair of shoulder main grooves 18B and 18B disposed on both sides are provided. Each of the three main grooves 18 is a zigzag groove extending in the tire circumferential direction C while being bent. Moreover, the main groove 18 is a circumferential groove having a groove width (opening width) of generally 5 mm or more.

A plurality of land portions partitioned by the main grooves 18 are formed in the tread portion 16. The plurality of lateral grooves 20 are provided at intervals in the tire circumferential direction C. Therefore, each land portion is formed as the block row 22 formed by disposing a plurality of blocks in the tire circumferential direction C. More specifically, a pair of right and left center land portions sandwiched between the center main groove 18A and the shoulder main grooves 18B is formed as center block rows 22A formed by disposing a plurality of center blocks 24 in the tire circumferential direction C by providing lateral grooves 20A. The center block row 22A is a block row positioned at a central portion in the tire width direction W in the tread portion 16. In addition, a pair of right and left shoulder land portions sandwiched between the shoulder main groove 18B and a tire ground contact end E is formed as shoulder block rows 22B formed by disposing a plurality of shoulder blocks 26 in the tire circumferential direction C by providing the lateral grooves 20B. The shoulder block rows 22B are block rows positioned at both end portions in the tire width direction in the tread portion 16.

The lateral grooves 20A and 20B are grooves extending in a direction intersecting main grooves 18A and 18B, and crossing each land portion. The lateral grooves 20A and 20B may not necessarily be parallel to the tire width direction W as long as they are grooves extending in the tire width direction W. In the example, the lateral grooves 20A and 20B are grooves extending in the tire width direction W while being inclined.

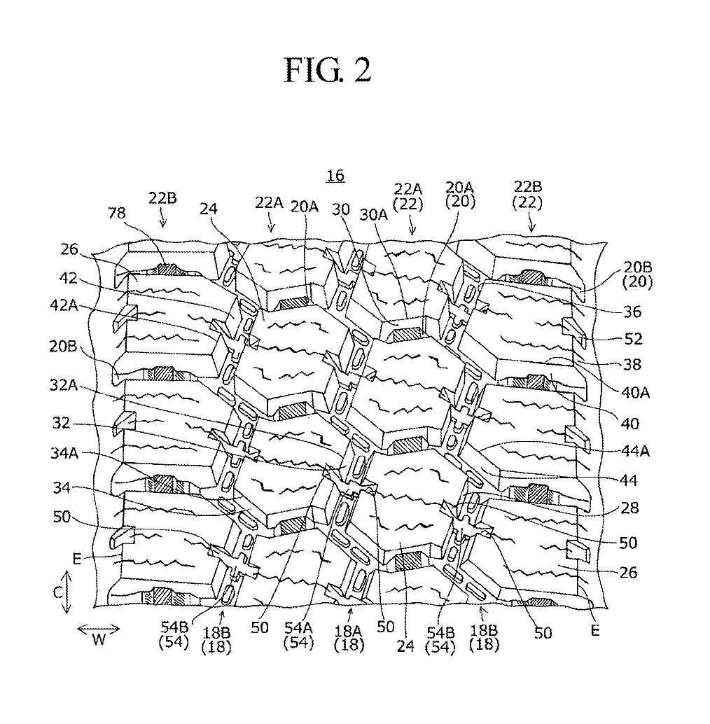

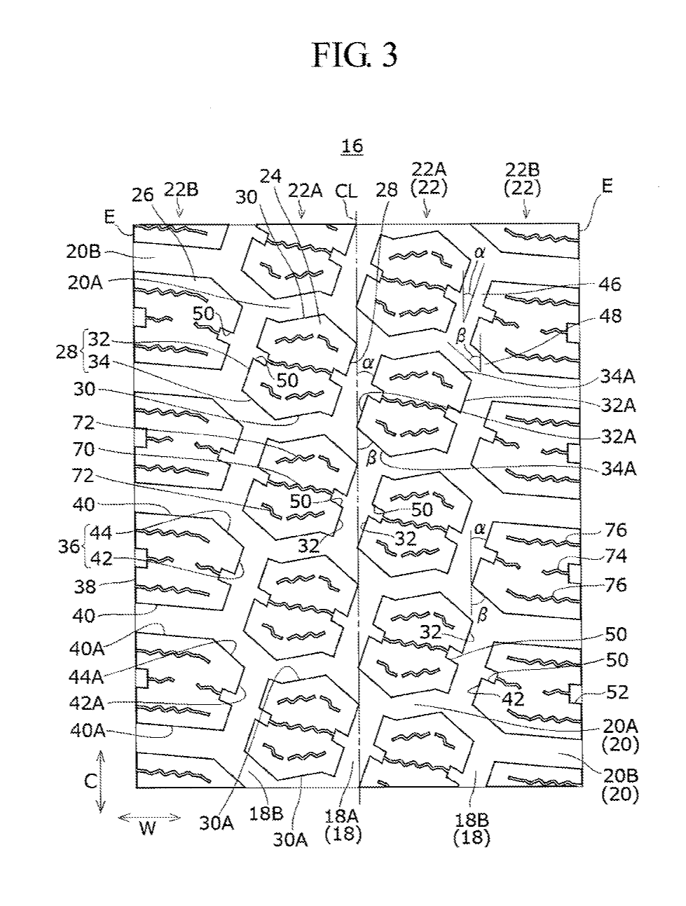

As illustrated in FIGS. 2 and 3, the center block 24 includes a pair of right and left longitudinal side surface portions 28 and 28 facing the right and left main grooves 18A and 18B, and a pair of front and rear lateral side surface portions 30 and 30 facing the front and rear lateral grooves 20A and 20A. Here, the longitudinal side surface portion 28 is a side surface portion facing the main groove 18 (that is, configuring a part of a groove wall surface of the main groove by being in contact with the main groove) out of side surface portions of the block 24. The lateral side surface portion 30 is a side surface portion facing the lateral groove 20 (that is, configuring a part of a groove wall surface of the lateral groove by being in contact with the lateral groove) out of the side surface portions of the block 24.

The pair of longitudinal side surface portions 28 and 28 is formed of a pair of first longitudinal side surface portions 32 and 32 having ridgelines 32A and 32A parallel to each other inclined with respect to the tire circumferential direction C, and a pair of second longitudinal side surface portions 34 and 34 having ridgelines 34A and 34A parallel to each other inclined greater with respect to the tire circumferential direction C than the ridgelines 32A of the first longitudinal side surface portions 32. Here, the ridgeline is a line generated at an intersection between a side surface and an upper surface (tread surface) of a block. The ridgeline 32A of the first longitudinal side surface portion 32 has a linear shape that is inclined to one side at an angle α with respect to the tire circumferential direction C. The ridgeline 34A of the second longitudinal side surface portion 34 has a linear shape that is inclined to another side at an angle β (β>α) with respect to the tire circumferential direction C. The ridgeline 34A of the second longitudinal side surface portion 34 is set shorter than the ridgeline 32A of the first longitudinal side surface portion 32. In addition, the second longitudinal side surface portion 34 is formed so as to intersect the first longitudinal side surface portion 32 at an obtuse angle.

The pair of lateral side surface portions 30 and 30 is side surface portions having ridgelines 30A and 30A parallel to each other inclined with respect to the tire width direction W. The lateral side surface portion 30 is a side surface portion that is interposed between the first longitudinal side surface portion 32 of one longitudinal side surface portion 28 and the second longitudinal side surface portion 34 of the other longitudinal side surface portion 28, and connects them. As described above, the center block 24 has a substantially hexagonal shape (convex hexagonal shape) in a plan view.

The shoulder block 26 includes a longitudinal side surface portion 36 facing the shoulder main groove 18B, a longitudinal side surface portion 38 facing the tire ground contact end E (that is, configuring a part of a ground contact end wall), and a pair of front and rear lateral side surface portions 40 and 40 facing the front and rear lateral grooves 20B and 20B. The longitudinal side surface portions 36 and 38 are side surface portion facing the main groove 18 or the ground contact end E out of the side surface portions of the shoulder block 26. The lateral side surface portion 40 is a side surface portion facing the lateral groove 20B out of the side surface portions of the shoulder block 26.

Similar to the longitudinal side surface portion 28, the longitudinal side surface portion 36 facing the shoulder main groove 18B is formed of a third longitudinal side surface portion 42 having a ridgeline 42A inclined with respect to the tire circumferential direction C, and a fourth longitudinal side surface portion 44 having a ridgeline 44A inclined greater with respect to the tire circumferential direction C than the ridgeline 42A of the third longitudinal side surface portion 42. The ridgeline 42A of the third longitudinal side surface portion 42 has a linear shape that is inclined to one side at the angle α with respect to the tire circumferential direction C. The ridgeline 44A of the fourth longitudinal side surface portion 44 has a linear shape that is inclined to another side at the angle β(β>α) with respect to the tire circumferential direction C. In addition, the ridgeline 44A of the fourth longitudinal side surface portion 44 is shorter than the ridgeline 42A of the third longitudinal side surface portion 42. Furthermore, the fourth longitudinal side surface portion 44 is formed to intersect the third longitudinal side surface portion 42 at an obtuse angle.

The pair of lateral side surface portions 40 and 40 is a side surface portion having ridgelines 40A and 40A parallel to each other inclined with respect to the tire width direction W. As described above, the shoulder block 26 has a substantially pentagonal shape (convex pentagonal shape) in a plan view.

Because of the shapes of the center block 24 and the shoulder block 26 described above, the main groove 18 and the lateral groove 20 are provided as follows. As illustrated in FIG. 3, the main groove 18 has a first groove portion 46 that is inclined to one side at the angle α with respect to the tire circumferential direction C and a second groove portion 48 that is inclined to another side at an angle β with respect to the tire circumferential direction C, which are alternately repeated via an obtuse angle bent portion in the tire circumferential direction C thereby forming a zigzag shape. The second groove portion 48 is shorter than the first groove portion 46 and the inclined angle β with respect to the tire circumferential direction C is set greater than the inclined angle α of the first groove portion 46. Moreover, between adjacent main grooves 18A and 18B, top portions of the bent portions are disposed to face each other, the top portions are connected by the lateral groove 20A, and thereby the center block rows 22A are formed. In addition, the lateral grooves 20B are provided outward of the shoulder main groove 18B in the tire width direction from the top portion of each bent portion to the tire ground contact end E and thereby the shoulder block rows 22B are fanned.

As illustrated in FIGS. 2 to 4, recessed notches 50 and 50 respectively extending from the block upper surface toward the block bottom portion are provided at the side surface portions of the blocks 24 and 26 facing each other with the main groove 18 interposed therebetween. The notch 50 is a U-shaped recess in a plan view cut out toward a groove bottom of the main groove 18 from a block upper surface to a block bottom portion.

Specifically, the notches 50 and 50 are respectively provided at the central portion in the first longitudinal side surface portions 32 and 32 of the center blocks 24 and 24 facing each other with the center main groove 18A interposed therebetween. The notches 50 are provided at the central portion in a ridgeline direction of the first longitudinal side surface portion 32, that is, in the vicinity of the center of the ridgeline, and are provided at the side surface portions 32 and 32 facing each other one by one.

In addition, in the center block 24 and the shoulder block 26 facing each other with the shoulder main groove 18B interposed therebetween, the notches 50 and 50 are respectively provided at each central portion in the first longitudinal side surface portion 32 and the third longitudinal side surface portion 42 facing the first longitudinal side surface portion 32. The notches 50 are provided at the central portions in the ridgeline direction of the first longitudinal side surface portion 32 and the third longitudinal side surface portion 42, that is, in the vicinity of the center of the ridgeline, and are provided at the side surface portions 32 and 42 facing each other one by one. Moreover, in the example, in the shoulder block 26, similar recessed notch 52 is also provided at the central portion of the longitudinal side surface portion 38 facing the tire ground contact end E.

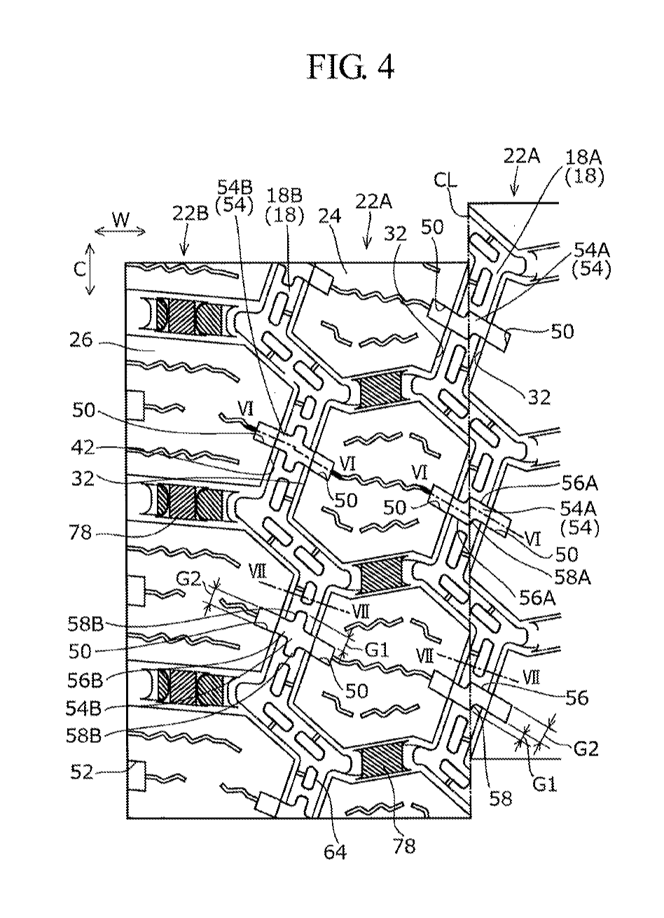

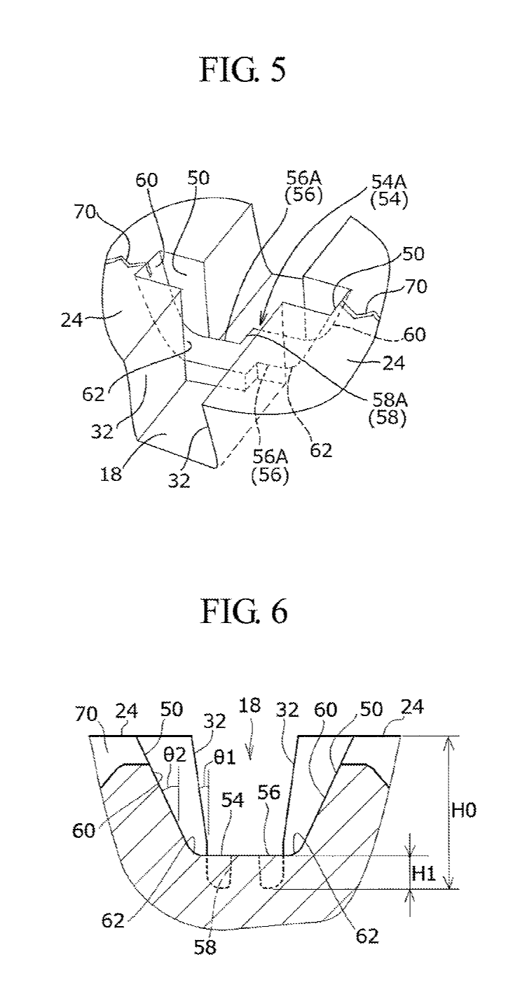

As illustrated in FIGS. 4 and 5, a reinforcing projection portion 54 connecting the notches 50 and 50 facing each other with the main groove 18 interposed therebetween is provided between the notches 50 and 50. The reinforcing projection portion 54 is a protrusion which crosses the main groove 18 so as to connect the bottom portions of the notches 50 and 50 facing each other, and protrudes from the groove bottom of the main groove 18.

The reinforcing projection portion 54 includes a longitudinal component 58 extending in the length direction of the main groove 18 together with a lateral component 56 extending in a direction crossing to the main groove 18. The longitudinal component 58 is a component extending along the length direction of the main groove 18 extending in the tire circumferential direction C at the central portion in the width direction of the main groove 18. Specifically, as illustrated in FIG. 4, a reinforcing projection portion 54A connecting between notches 50 and 50 facing each other with the center main groove 18A interposed therebetween is a crank-shaped projection portion formed by connecting a pair of the lateral components 56A and 56A shifted in position in the length direction of the main groove extending from each of the notches 50 and 50 in a bent shape via a longitudinal component 58A. On the other hand, a reinforcing projection portion 54B connecting between the notches 50 and 50 facing each other with the shoulder main groove 18B interposed therebetween is a cross-shaped projection portion of which longitudinal components 58B and 58B are respectively and projectingly formed from a central portion of the lateral components 56B crossing the shoulder main grooves 18B on both sides in the length direction of the main groove.

In the example, an extension amount in the length direction of the main groove of the longitudinal component 58 (that is, a protrusion amount from the lateral component 56) G1 is set to 40% or more of a width G2 of the lateral component 56. The extension amount G1 may be 40 to 100% with respect to the width G2.

As illustrated in FIGS. 5 and 6, the notch 50 has an inclined surface 60 inclined so as to approach the main groove 18 on a side closer to the block bottom portion. The inclined surface 60 is provided from the upper end to the lower end of the notch 50, and is connected to the upper surface of the reinforcing projection portion 54 via a curved surface portion 62 at the lower end portion. The inclined surface 60 is formed with a gentle gradient more than the groove wall surface (groove wall surfaces on both sides of the notch 50, in the example, the first longitudinal side surface portion 32 and the third longitudinal side surface portion 42) of the main groove 18. That is, as illustrated in FIG. 6, an inclined angle θ2 (with respect to a vertical plane) of the inclined surface 60 of the notch 50 is set greater than an inclined angle θ1 (with respect to the vertical plane) of the groove wall surface of the main groove 18 (θ2>θ1).

The reinforcing projection portion 54 is a protrusion lower than a height of the blocks 24 and 26. In the example, a height H1 of the reinforcing projection portion 54 in the main groove 18 is set to 10 to 30% of the main groove depth H0. The height H1 of the reinforcing projection portion 54 is 10% or more of the main groove depth H0 and thereby the stone drilling effect can be enhanced by the reinforcing projection portion 54. In addition, if it is 30% or less, it is possible to suppress the movement of the reinforcing projection portion 54 and make chipping less likely to occur.

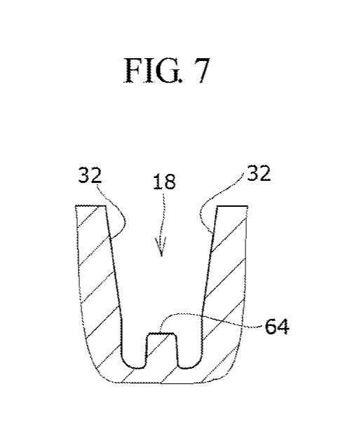

As illustrated in FIGS. 4 and 7, a plurality of protrusions 64 are intermittently provided in the groove bottom of the main groove 18 in order to improve the anti-stone drilling property. The protrusion 64 is an elongated protrusion extending in the length direction of the main groove provided in the central portion in the width direction of the main groove 18, and a plurality of protrusions 64 are arranged between the front and rear reinforcing projection portions 54 and 54. A height of the protrusion 64 is set to the same height as the height H1 of the reinforcing projection portion 54.

As illustrated in FIGS. 2 to 4, in each of the blocks 24 and 26, a sipe as a cut is provided in order to improve the traction property. In detail, the center block 24 is provided with a first sipe 70 which opens into the notches 50 and extends in the tire width direction W connecting the notches 50 and 50 on both sides. The center block 24 also has second sipes 72 extending in the tire width direction W, respectively on both sides in the tire circumferential direction of the first sipe 70, and both ends of which terminate within the block 24. Two third sipes 74 extending in the tire width direction W are provided in the shoulder block 26, one end of which opens into the notches 50 and 56 and the other end terminates within the shoulder block 26. Fourth sipes 76 extending in the tire width direction W are provided in the shoulder block 26 and on both sides of the third sipes 74 in the tire circumferential direction, one end of which opens into the tire ground contact end E and the other end terminates within the shoulder block 26. In the example, the sipes 70, 72, 74, and 76 are zigzag-shaped sipes that are bent at a plurality of positions, but may be linear sipes. The groove width of the sipes 70, 72, 74, and 76 is not particularly limited, and may be, for example, 0.1 to 1.5 mm or 0.3 to 0.8 mm.

In the lateral groove 20, bridge portions 78 respectively connecting between the front and rear center blocks 24 and 24, and between the front and rear shoulder blocks 26 and 26 are provided in a raised shape at the groove bottom of each of the lateral grooves 20. Therefore, the lateral groove 20 is formed shallower than the main groove 18.

According to the embodiment having the above structure, the notches 50 and 50 are respectively provided at the side surface portions 32 and 42 of the blocks 24 and 26 facing each other with the main groove 18 interposed therebetween. Therefore, it is possible to increase the number of traction elements and improve the traction property. In addition, the notches 50 are provided at the central portions of the first longitudinal side surface portion 32 and the third longitudinal side surface portion 42. Therefore, it is possible to eliminate a difference in rigidity in the respective blocks 24 and 26, and to suppress uneven wear.

In addition, the reinforcing projection portion 54 connecting between the notches 50 and 50 is provided in the groove bottom of the main groove 18. Therefore, the rigidity of the blocks 24 and 26 reduced by the notches 50 is secured, the movement of the blocks 24 and 26 is suppressed, and thereby the uneven wear resistance property can be improved. In addition, the reinforcing projection portion 54 can suppress the stone drilling. Therefore, it is possible to maintain the traction property by the notches 50 and to improve the uneven wear resistance property while suppressing the stone drilling.

According to the embodiment, the reinforcing projection portion 54 has a longitudinal component 58 extending in the length direction of the main groove 18 together with the lateral component 56 extending in the direction crossing the main groove 18. Therefore, it is possible to suppress simultaneous deformation between the blocks 24 and 26 connected by the reinforcing projection portion 54 and to suppress occurrence of uneven wear at the time of driving and braking compared to a case where the longitudinal component 58 is not provided. In particular, if the crank-shaped projection portion as the reinforcing projection portion 54A of the center main groove 18A is used, the movement between the blocks 24 and 24 connected by the reinforcing projection portion 54 can be effectively shifted, and it is excellent in suppression effect in uneven wear.

In addition, the extension amount G1 of the longitudinal component 58 of the reinforcing projection portion 54 in the length direction of the main groove is 40% or more of the width G2 of the lateral component 56. Therefore, it is possible to enhance the reinforcing effect and enhance a suppressing effect of the simultaneous deformation, and improve the uneven wear resistance property at the time of driving and braking.

In addition, the notch 50 is provided with the inclined surface 60 which is inclined so as to approach the main groove 18 on a side closer to the block bottom portion, and the inclined surface 60 is formed with a gentle gradient more than the groove wall surfaces 32 and 42 of the main groove 18. Therefore, the reinforcing effect of the blocks 24 and 26 can be improved.

In the embodiments described above, the number of the main grooves 18 is three, but the number of the main grooves is not particularly limited and, for example, may be four or five. It is preferable that the number of the main grooves is three or four. In addition, although the main groove 18 is a zigzag-shaped groove, it may be a straight groove or a tread pattern combining the zigzag-shaped groove and the straight groove. In addition, the notches 50 are provided on all the side surface portions of the blocks 24 and 26 facing each other with the main groove 18 interposed therebetween and are connected by the reinforcing projection portions 54, but they may not be necessarily applied to all the blocks.

The pneumatic tire according to the embodiment includes various vehicle tires such as a tire for a passenger car, a heavy duty tire of a truck, a bus, or a light truck (for example, an SUV vehicle or a pickup truck) or the like. In addition, applications such as a summer tire, a winter tire, and all-season tire are not particularly limited. It is preferable that the tire is the heavy duty tire.

Each dimension described above in the present specification is provided in a regular state with no load in which the pneumatic tire is mounted on a regular rim and is filled with air of a regular internal pressure. The regular rim is a “standard rim” in the JATMA standard, a “Design Rim” in the TRA standard, or a “Measuring Rim” in the ETRTO standard. The “regular internal pressure” is the “maximum air pressure” in the JATMA standard, the “maximum value” described in “TIRE LOAD LIMITS AT VARIOUS COLD INFLATION PRESSURES” in the TRA standard, or “INFLATION PRESSURE” in the ETRTO standard.

### EXAMPLES

In order to confirm the above effects, each heavy duty pneumatic tire (tire size: 11R22.5) of Examples 1 to 3, and Comparative Example 1 was mounted on a rim of 22.5×7.50, filled with air of an internal pressure of 700 kPa, mounted on a vehicle with a constant loading capacity of 10 t, and evaluated for the uneven wear resistance property, the traction property, and the anti-stone drilling property. The tire of Example 3 includes features of the embodiment illustrated in FIGS. 1 to 7 (groove width of the main groove=11.5 mm, the depth of the main groove H0=16.5 mm, the inclined angle of the wall surface of the main groove θ1=8°, the inclined angle of the inclined surface of the notch θ2=25°, the height of the reinforcing projection portion H1=3.5 mm, a ratio between the extension amount G1 of the longitudinal component and the width G2 of the lateral component G1/G2=0.5 at the crank-shaped reinforcing projection portion of the center main groove, and the longitudinal components on the both sides respectively G1/G2=0.8 at the cross-shaped reinforcing projection portion of the shoulder main groove). In the tire of Example 2, the inclined angle θ2 of the inclined surface 60 of the notch 50 was set to the inclined angle θ1 of the groove wall surface of the main groove 18 (θ2=θ1)=8°, and the other configuration was the same as that of the tire of Example 3. In the tire of Example 1, the reinforcing projection portion 54 is formed in a straight shape of only the lateral component 56 (without the longitudinal component 58), and the other configuration was the same as that of the tire of Example 2. In the tire of Comparative Example 1, the reinforcing projection portion 54 is not provided and the other configuration was the same as that of the tire of Example 1.

Each evaluation method is as follows.

The uneven wear resistance property: an uneven wear state (heel and toe wear amount) after traveling 20,000 km was measured and an inverse number of the heel and toe wear amount was indexed with the value of Comparative Example 1 taking as 100. The larger the index, the less occurrence of uneven wear and more excellent in the uneven wear resistance property.

The traction property: an arrival time when advanced 20 m from a stop state on a road surface having a water depth of 1.0 mm was measured, and an inverse number of the arrival time was indexed with the value of Comparative Example 1 taking as 100. The larger the index, the shorter the arrival time and the better the traction property.

The anti-stone drilling property: an amount and depth of a crack or a cut of the main groove bottom after traveling 20,000 km was measured and was indexed with the measured result of Comparative Example 1 taking as 100. The larger the index, the smaller the crack or the cut and more excellent in the anti-stone drilling property.

TABLE 1

| | Comparative | | | |
|---|---|---|---|---|
| | Example 1 | Example 1 | Example 2 | Example 3 |
| Presence or absence of | No | Yes | Yes | Yes |
| reinforcing projection | | | | |
| portion | | | | |
| Shape of reinforcing | — | Straight shape | Having | Having |
| projection portion | | | longitudinal | longitudinal |
| | | | component | component |
| Inclined angle of inclined | θ2 = θ1 | θ2 = θ1 | θ2 = θ1 | θ2 > θ1 |
| surface of notch | | | | |
| Uneven wear resistance | 100 | 105 | 109 | 114 |
| property | | | | |
| Traction property | 100 | 100 | 100 | 100 |
| Anti-stone drilling property | 100 | 107 | 107 | 107 |

The results are illustrated in Table 1 and it is possible to improve the uneven wear resistance property without impairing the traction property and the anti-stone drilling property was also improved by providing reinforcing projection portions in Example 1 compared to Comparative Example 1 in which the reinforcing projection portion is not provided. In Example 2, since the longitudinal component was added to the reinforcing projection portion in Example 1, the uneven wear resistance property was further improved. In addition, in Example 3, since the inclined surface of the notch was formed with a gentler gradient more than the groove wall surface of the main groove, the uneven wear resistance property was further improved than that of Example 2.

While several embodiments are described above, these embodiments are presented by way of example and are not intended to limit the scope of the invention. These novel embodiments can be implemented in various other forms, and various omissions, substitutions, and changes can be made without departing from the spirit of the invention.

What is claimed is:

1. A pneumatic tire comprising:
a tread portion including a plurality of main grooves extending in a tire circumferential direction, a plurality of lateral grooves extending in a direction intersecting the main grooves, and block rows formed by the main grooves and the lateral grooves, and having a plurality of blocks in a tire circumferential direction,
wherein recessed notches extending from a block upper surface toward a block bottom portion are respectively provided in side surface portions of the blocks facing each other with the main groove interposed therebetween, and a reinforcing projection portion connecting the notches is provided in a groove bottom of the main groove.

2. The pneumatic tire according to claim 1,
wherein the reinforcing projection portion includes a lateral component extending in a direction crossing the main groove and a longitudinal component extending in a length direction of the main groove.

3. The pneumatic tire according to claim 2,
wherein an amount of extension of the longitudinal component in the length direction of the main groove is 40% or more of a width of the lateral component.

4. The pneumatic tire according to claim 2,
wherein the reinforcing projection portions is a crack-shaped projection portion formed by connecting a pair of the lateral components respectively extending from a pair of notches facing each other to be a bent shape via the longitudinal component.

5. The pneumatic tire according to claim 2,
wherein the reinforcing projection portion is a cross-shaped projection portion of which the longitudinal components are respectively and projectingly formed from a central portion of the lateral component crossing the main groove on both sides in the length direction of the main groove.

6. The pneumatic tire according to claim 1,
wherein the notches include inclined surfaces which are inclined so as to approach the main groove on a side closer to the block bottom portion, and the inclined surfaces are formed with a gentle gradient more than a groove wall surface of the main groove.

7. The pneumatic tire according to claim 1,
wherein the notches are respectively provided at central portions of the side surface portions of the blocks facing each other with the main groove interposed therebetween.

8. The pneumatic tire according to claim 1,
wherein a height of the reinforcing projection portion is 10 to 30% of a depth of the main groove.
